(19) United States
(12) Patent Application Publication
(10) Pub. No.: US 2024/0391473 A1
(43) Pub. Date: Nov. 28, 2024

(54) METHOD AND DEVICE FOR CONTROLLING A DRIVING FUNCTION OF A MOTOR VEHICLE

(71) Applicants: CARIAD SE, Wolfsburg (DE); VOLKSWAGEN AKTIENGESELLSCHAFT, Wolfsburg (DE)

(72) Inventors: Bastian HERMANN, Berlin (DE); Ermis GASETOPULOS, Berlin (DE); Daniel MUENNING, Braunschweig (DE)

(21) Appl. No.: 18/671,758

(22) Filed: May 22, 2024

(30) Foreign Application Priority Data
May 23, 2023 (DE) 102023113456.6

(51) Int. Cl. B60W 50/00

(52) U.S. Cl. CPC B60W 50/0098; B60W 2556/45

(57) ABSTRACT

The disclosure relates to a method for controlling a driving function of a motor vehicle, comprising capturing a location of the motor vehicle, capturing an environment of the motor vehicle, ascertaining information relevant to the driving function in the environment of the motor vehicle, retrieving falsification information regarding the information relevant to the driving function from a data memory remote from the motor vehicle based on the location and controlling the driving function based on the falsification information.

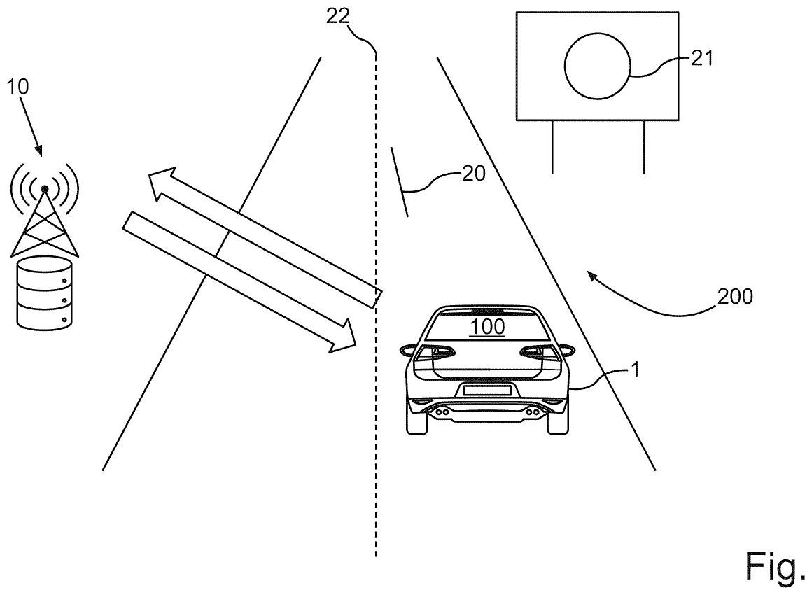

### BACKGROUND

The present disclosure relates to a method and to a device for controlling a driving function of a motor vehicle as well as to a motor vehicle.

### TECHNICAL FIELD

Advanced driving assistance systems are capable of recognizing and considering various information in the environment of a motor vehicle, such as for example lane markings or speed limits. Therein, however, in particular in outdated recognition systems, false or incorrect recognitions can occur, which can result in a false operation by the driving assistance systems.

### DESCRIPTION OF THE RELATED ART

### Brief Summary

Embodiments of the present disclosure provide an improved method, an improved device for controlling a driving function of a motor vehicle as well as an improved motor vehicle.

According to a first aspect, a method for controlling a driving function of a motor vehicle is specified. Therein, the method according to the disclosure includes the steps of capturing a location of the motor vehicle, capturing an environment of the motor vehicle, ascertaining information relevant to the driving function in the environment of the motor vehicle, retrieving falsification information regarding the information relevant to the driving function from a data memory remote from the motor vehicle based on the location and controlling the driving function based on the falsification information.

In particular, the method serves for ascertaining incorrect or false recognitions of information present in the environment of the motor vehicle and preventing the consideration of this incorrect information.

In the following, the term information is used both in singular and plural, which are synonymous to each other and are to include data, also an individual or single datum, in any case.

In a first step of the method, a location of the motor vehicle is captured.

The location of the motor vehicle can be captured via a location or position sensor such as for example a GPS sensor, which is provided in the motor vehicle. Hereto, map data, which is provided in a memory of the motor vehicle, can in particular also be retrieved. Therein, the location for example includes one or more coordinates and/or an address, by which the location or the position of the motor vehicle can be sufficiently accurately determined.

In a further step, an environment of the motor vehicle is captured. In particular, an exterior space around the motor vehicle is captured. In particular, at least a part of the environment or of the exterior space includes a section in direction of travel of the motor vehicle.

In particular, the environment includes the road, on which the motor vehicle is located or drives at the current point of time, and the shoulder in particular adjoining on the right side or a right roadside. The environment can also include an oncoming lane, thus a lane of the oncoming traffic.

Therein, the environment can in particular be captured in one or more images, for example by a suitable image capturing device and/or a lidar and/or radar device, which in particular points in direction of travel or the motor vehicle or is arranged on the front side of the motor vehicle, for example on a radiator grille and/or a front bumper. In particular, the capturing device is formed to regularly, periodically and/or continuously capture images of the exterior space.

In a further step, information relevant to a driving function of the motor vehicle in the environment of the motor vehicle is ascertained. In particular, one or more relevant information is ascertained in the captured image or images. In particular, this can be effected by way of suitable evaluation or recognition algorithms, for example via an edge and/or contrast recognition, pattern matching and/or a classification, in particular with the aid of artificial intelligence.

Information relevant to the motor vehicle is in particular information, which relates to a control of the motor vehicle and/or a control of a driving function. In particular, the information relevant to the motor vehicle is information, which is arranged in the environment and relates to a drive and/or a safety of the motor vehicle. For example, the information relevant to the motor vehicle is a marking, a boundary, a light signal and/or a sign, in particular a mandatory or prohibition sign, which in particular affects or relates to the operation and/or the drive of the motor vehicle. For example, the relevant information is a speed limit, a traffic light and/or a ground marking.

In particular, the information relevant to the motor vehicle is allegedly relevant information or information, which is first or preliminarily assessed as relevant, but possibly is not at all.

For example, the ascertained information is allegedly a speed limit, but actually an advertisement poster, which is the spitting image of a speed limit. Again for example, the ascertained information is allegedly a lane boundary, but actually a tar seam, a reflection and/or an invalid construction site marking, which is the spitting image of a valid ground marking. Again for example, the ascertained information is allegedly a traffic light, which in particular shows red or green, but actually is an advertisement poster, which is the spitting image of a traffic light. Also for example, the ascertained information is allegedly a speed limit, which relates to the lane of the motor vehicle, but actually is a speed limit, which relates to another lane, for example a turning lane, on which the motor vehicle is not located and which therefore does not apply hereto. This allegedly relevant information or these objects can also be referred to as ghost objects.

This difference in the alleged and actual relevance is then verified or falsified according to the disclosure as it will be described in the following. In particular, this has to occur because the capturing device and/or the evaluation algorithms are not powerful enough to recognize this false or non-present relevance of the information as such, at least not in reliable manner.

In a further step, falsification information regarding the relevant information is then retrieved from a data memory remote from the motor vehicle based on the location.

Therein, the data memory remote from the motor vehicle is for example arranged in a computing center or a processing device and includes falsification information and optionally also verification information to one or more locations.

Therein, retrieving, which can also be referred to as receiving, is effected via a suitable communication device of the motor vehicle, in particular a wireless communication device, such as for example a mobile radio, in particular 3G, 4G, 5G, Bluetooth-, WLAN and/or Car2X interface.

Therein, falsification information is in particular information or a datum such as for example a flag or a classification of the determined, allegedly relevant information as false and/or as irrelevant. Thereto, the relevance or irrelevance can be recorded in the data memory to different locations and/or different relevant information, in particular together with further information like the accurate position, the type and/or the property of the allegedly relevant information.

In a further step, a driving function is controlled based on the falsification information.

For example, a driving function can include a drive or a steering. In particular, a driving function includes an assistance function such as for example a lane keeping assistant, a collision avoiding assistant and/or an emergency braking assistant. Further in particular, a driving function can also include a partially or completely autonomous driving function, driving assistance function or driving assistance.

Controlling the driving function can for example include acceleration, deceleration and/or steering, which can be controlled, in particular initiated, in response to the determination that the allegedly relevant information is irrelevant information.

In addition, verification information can also be retrieved and an opposite control of a driving function can be initiated or controlled thereupon.

By the method according to the disclosure, it is allowed to reliably exclude incorrect recognitions and in particular incorrect operations of the motor vehicle based thereon.

According to a development, the falsification information is based on a falsification by a vehicle different from the motor vehicle.

In particular, the remote data memory is formed to receive and to store falsification information regarding allegedly relevant information and the associated location of multiple motor vehicles, in particular of more than 10, more than 100 or more than 1000 motor vehicles, in particular per year, per month or per day. In particular, the data memory remote from the motor vehicle receives falsification information from all of the motor vehicles configured thereto of a manufacturer and/or fleet operator.

Further in particular, the vehicles different from the receiving motor vehicle are those vehicles, which have better capturing devices and/or evaluation algorithms than the motor vehicle, in particular those, which are powerful enough to, in particular reliably, recognize this false or non-present relevance of the information as such.

In particular, the falsification information was determined or ascertained by the different vehicle and provided to the remote data memory, further in particular before the motor vehicle has retrieved the falsification information.

By this development, recognitions of relevant information can also be indirectly reliably allowed for motor vehicles, which have inferior capturing devices and/or evaluation algorithms.

According to a development, the falsification information is based on a manual driving intervention of a driver of a vehicle different from the motor vehicle.

A manual driving intervention of the driver presently includes countersteering, braking or accelerating, in particular in contrast to the function or an operation of an assistance function. In particular, the manual driving intervention includes turning off a driving assistance function or an action opposite to the function of the driving assistance function.

This falsification information too and in particular the driving intervention associated therewith as well as also the extent thereof can be provided to the remote data memory, further in particular before the motor vehicle has retrieved the falsification information.

By this development, it is allowed to particularly simply ascertain the falsification information.

According to a development, the falsification information is based on non-ascertainment of information relevant to a driving function by a vehicle different from the motor vehicle.

In particular, a vehicle different from the motor vehicle can retrieve allegedly relevant information at a certain location, but recognize by the better capturing devices and/or evaluation algorithms present in the vehicle that the retrieved information is false, meaning only allegedly relevant information. Presently, previously allegedly relevant information was in particular captured, but which has turned out to be actually irrelevant afterwards. Thereby, the vehicle different from the motor vehicle falsifies the information.

This falsification information too and in particular the non-ascertainment associated therewith as well as also the extent thereof can be provided to the remote data memory, further in particular before the motor vehicle has retrieved the falsification information.

By this development too, it is allowed to particularly simply ascertain the falsification information.

According to a development, the falsification information is based on a change of information relevant to a driving function in the remote data memory.

Presently, information previously characterized as relevant was in particular characterized as irrelevant or not relevant. This can in particular be effected due to a manual user intervention by a data managing person or by an algorithm, in particular artificial intelligence, which recognizes and/or evaluates deviations, irregularities and/or differences of the provided data by the motor vehicle and in particular vehicles different therefrom.

In particular, this can also be effected before the motor vehicle has retrieved the falsification information.

By this development too, it is allowed to particularly simply ascertain the falsification information.

According to a development, the control of the driving function includes disregarding the relevant information.

Presently, disregarding the relevant driving function in particular means the realization that it is an allegedly relevant information, which has been ascertained as relevant information before and thus actually would have to cause a control of the driving function, but now is not taken as a basis for a control of the driving function.

Presently, a driving function is in particular controlled with exclusion of the alleged relevant information. Further in particular, a driving function is not initiated despite of knowledge of the allegedly relevant information.

By this development too, it is allowed to particularly simply ascertain the falsification information.

According to a development, the control of the driving function includes deactivation of a driving assistance function of the motor vehicle.

For example, a driving assistance function can include a lane keeping assistant, a collision avoiding assistant, a speed control assistant and/or an emergency braking assistant. Further in particular, a driving assistance function can also include a partially or completely autonomous driving function, driving assistance function or driving assistance.

Presently, a deactivation in particular means turning off a previously activated driving assistance function or suppression of turning on a driving assistance function.

In particular, in that an allegedly relevant information is recognized as such, such an assistance function can be, in particular temporarily, turned off or not turned on. For example, an alleged speed limit can be disregarded by a speed control assistant or an alleged lane boundary can be disregarded by a lane keeping assistant.

By this development, it is allowed to particularly efficiently respond to the falsification information. Thus, a particularly safe drive is allowed.

For application cases or application situations, which can arise in the method and which are not explicitly described here, it can be provided that an error message and/or a request for inputting a user feedback are output and/or a default setting and/or a predetermined initial state are adjusted according to the method.

According to a further aspect, a device is specified. The device can comprise a data processing device or a processor device, which is configured to perform an embodiment of the method according to the disclosure.

Hereto, the processor device can comprise at least one microprocessor and/or at least one microcontroller and/or at least one FPGA (Field Programmable Gate Array) and/or at least one DSP (Digital Signal Processor). Furthermore, the processor device can comprise a program code, which is configured to perform the embodiment of the method according to the disclosure upon execution by the processor device. The program code can be stored in a data memory of the processor device. The processor device can be based on, for example, at least one circuit board and/or on at least one SoC (System on Chip).

According to a further aspect, a motor vehicle is specified, which includes such a device.

The motor vehicle according to the disclosure is preferably configured as a car, in particular as a passenger car or truck, or as a passenger bus or motorcycle.

As a further solution, the disclosure also includes a computer-readable storage medium comprising program code, which, upon execution by a computer or a computer cluster, causes it to execute an embodiment of the method according to the disclosure. The storage medium can be provided at least partially as a non-volatile data memory (e.g., as a flash memory and/or as an SSD-solid state drive) and/or at least partially as a volatile data memory (e.g., as RAM-random access memory). The storage medium can be arranged in the computer or computer cluster. However, the storage medium can for example also be operated as a so-called Appstore server and/or cloud server in the Internet. By the computer or computer cluster, a processor circuit with for example at least one microprocessor can be provided. The program code can be provided as a binary code and/or assembler code and/or as a source code of a programming language (e.g., C) and/or as a program script (e.g., Python).

The disclosure also includes the combinations of the features of the described embodiments. Thus, the disclosure also includes realizations, which each comprise a combination of the features of multiple of the described embodiments if the embodiments have not been described as mutually exclusive.

With respect to the embodiments of the device, of the motor vehicle and of the storage medium as well as to the associated advantages, reference is made to the previously described embodiments of the method and the advantages in this respect.

### BRIEF DESCRIPTION OF THE SEVERAL VIEWS OF THE DRAWING

In the following, embodiments of the disclosure are described.

The FIGURE shows a schematic view of an embodiment of a method and a device for controlling a driving function of a motor vehicle.

### DETAILED DESCRIPTION

The implementation examples explained in the following are advantageous embodiments of the disclosure. In the implementation examples, the described components of the embodiments each represent individual features of the disclosure to be considered independently of each other, which also each develop the disclosure independently of each other. Therefore, the disclosure also is to include combinations of the features of the embodiments different from the illustrated ones. Furthermore, the described embodiments can also be supplemented by further ones of the already described features of the disclosure.

In the FIGURES, identical reference characters each denote functionally identical elements.

The FIGURE shows a schematic view of an embodiment of a method and a device 100 for controlling a driving function of a motor vehicle 1.

Therein, the device 100 for driving assistance of a motor vehicle 1 is arranged in or at the motor vehicle 1 and therein includes devices, which are formed to execute a method for driving assistance. In particular, the device 100 includes one or more capturing devices, which are formed to capture an environment 200 of the motor vehicle 1 and a location of the motor vehicle 1.

The device 100 is also formed to ascertain information 20, 21 relevant to a driving function in the environment 200 of the motor vehicle 1.

The initially relevant information is both a ground marking 20 and a speed limit sign 21. However, this relevant information is only allegedly relevant and actually irrelevant to the motor vehicle and the driving function thereof, respectively. Actually, the ground marking 20 is a tar seam and the speed limit sign 21 is an advertisement.

Thereto, the device 100 is further formed to retrieve falsification information regarding the relevant information 20, 21 from a data memory 10 remote from the motor vehicle 1 based on the location and to control a driving function based on the falsification information.

The lane boundary 22 is also first ascertained as relevant information, wherein falsification information cannot be retrieved hereto because it does not exist. Rather, verification information is retrieved from the remote data memory 10 hereto, which verifies the information as relevant information.

Therein, the falsification information can be based on a falsification by a vehicle different from the motor vehicle 1, on a manual driving intervention of a driver of a vehicle different from the motor vehicle 1, on non-ascertainment of information 20, 21 relevant to a driving function of a vehicle different from the motor vehicle 1 or on a change of information relevant to a driving function in the remote data memory 10.

Therein, the control of the driving function can include disregarding the relevant information or deactivation of a driving assistance function of the motor vehicle 1.

Overall, the examples show how allegedly relevant information can be reliably falsified or verified for a driving function of a motor vehicle.

German patent application no. 10 2023 113 456.6, filed May 23, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for controlling a driving function of a motor vehicle, comprising:
capturing a location of the motor vehicle;
capturing an environment of the motor vehicle;
ascertaining information relevant to the driving function in the environment of the motor vehicle;
retrieving falsification information regarding the information relevant to the driving function from a data memory that is remote from the motor vehicle, based on the location; and
controlling the driving function based on the falsification information.

2. The method according to claim 1,
wherein the falsification information is based on a falsification by a vehicle different from the motor vehicle.

3. The method according to claim 1,
wherein the falsification information is based on a manual driving intervention of a driver of a vehicle different from the motor vehicle.

4. The method according to claim 1,
wherein the falsification information is based on non-ascertainment of the information relevant to the driving function of a vehicle different from the motor vehicle.

5. The method according claim 1,
wherein the falsification information is based on a change of the information relevant to the driving function in the data memory.

6. The method according to claim 1,
wherein the controlling of the driving function includes disregarding the information relevant to the driving function.

7. The method according to claim 1,
wherein the controlling of the driving function includes deactivating a driving assistance function of the motor vehicle.

8. A device for controlling a driving function of a motor comprising:
a processor; and
a memory storing program code that, when executed by the processor, causes the device to:
capture a location of the motor vehicle;
capture an environment of the motor vehicle;
ascertain information relevant to the driving function in the environment of the motor vehicle;
retrieve falsification information regarding the information relevant to the driving function from a data memory that is remote from the motor vehicle, based on the location; and
control the driving function based on the falsification information.

9. A motor vehicle comprising:
a device that includes:
a processor; and
a memory storing program code that, when executed by the processor, causes the device to:
capture a location of the motor vehicle;
capture an environment of the motor vehicle;
ascertain information relevant to the driving function in the environment of the motor vehicle;
retrieve falsification information regarding the information relevant to the driving function from a data memory that is remote from the motor vehicle, based on the location; and
control the driving function based on the falsification information.
